(19) United States
(12) Patent Application Publication
(10) Pub. No.: US 2018/0287366 A1
(43) Pub. Date: Oct. 4, 2018

(54) EMARKER AND ASSOCIATED CABLE AND METHOD

(71) Applicant: VIA Technologies, Inc., New Taipei City (TW)

(72) Inventors: Cheng-Chun YEH, New Taipei City (TW); Wei-Hang LIN, New Taipei City (TW); Yu-Lung LIN, New Taipei City (TW); Feng-Kuan SU, New Taipei City (TW)

(73) Assignee: VIA Technologies, Inc., New Taipei City (TW)

(21) Appl. No.: 15/868,422

(22) Filed: Jan. 11, 2018

Related U.S. Application Data
(60) Provisional application No. 62/479,342, filed on Mar. 31, 2017.

(30) Foreign Application Priority Data
Oct. 27, 2017 (TW) 106137054

(51) Int. Cl. H02H 3/00; H02H 5/04; H02H 1/00

(52) U.S. Cl. CPC H02H 3/00; H04L 12/40045; H02H 1/0007; H02H 5/041

(57) ABSTRACT

EMarker and associated cable and method. The cable includes a CC (configuration channel) wire, the eMarker includes an active trigger circuit and a protection circuit coupled to the active trigger circuit and the CC wire. When a second port connects a first port via the cable, if a predefined event happens, the active trigger circuit triggers the protection circuit to change an electric characteristic of the CC wire, such that the first port detects a detachment of the second port.

This application claims the benefit of a prior-filed provisional application Ser. No. 62/479,342, filed Mar. 31, 2017, and the benefit of Taiwan application Serial No. 106137054, filed Oct. 27, 2017, the subject matters of which are incorporated herein by references.

### FIELD OF THE INVENTION

The present invention relates to eMarker, associated cable and method, and more particularly, to USB type-C eMarker, associated cable and method for active and self-initialized protection of abnormal events such as over-current, over-voltage and/or over-temperature protection events.

### BACKGROUND OF THE INVENTION

USB (universal serial bus) type-C is an emerging and versatile interface standard; it not only supports typical USB data interconnect, but also includes various power supply options for supplying power from an electronic device to another electronic device, such as: supplying power from a portable power bank to a mobile phone, or supplying power from a host computer to a peripheral monitor, etc. The power supply options of USB type-C may include: 5V×0.5A of USB 2.0 (V and A respectively representing volt and ampere), 5V×0.9A of USB 3.1, 5V×1.5A of USB BC 1.2 (for USB type-A connector, with BC being battery charging), 5V×1.5A (for USB type-C connector), 5V×3.0A (for USB type-C connector), and a configurable supply of USB PD (power delivery) up to 20V×5A (for USB type-C connector).

To adapt the various power supply options, a USB type-C cable may be equipped with a CC (configuration channel) wire and an eMarker; when the cable connects a port which supports USB PD and is capable of operating as a source for providing power, the port may send a request message over the CC wire; the eMarker in the cable may receive the request message, and then respond a data message over the CC wire, such that the port may obtain information related to the cable, such as rated and/or tolerable voltage, current and/or power of the cable.

Because there are significant differences among powers of the different power supply options, supply safety becomes a main concern.

For supply safety, when a port which operates as a (power) source connects another port which operates as a (power) sink via a USB type-C cable, if both the two port support USB PD, the two ports may interchange alert messages of over-voltage and over-current. In other words, for the aforementioned power safety mechanism to work, a key requirement is that both the source port and the sink port must support USB PD. However, support of USB PD is not mandatory for a USB type-C port; if any one of the source port and the sink port does not support USB PD, such power safety mechanism will fail to work.

### SUMMARY OF THE INVENTION

To address issues of the aforementioned supply safety mechanism, an eMarker for a cable is provided in an embodiment of the invention; the cable may include a CC wire. The eMarker may include an active trigger circuit and a protection circuit. The protection circuit may be coupled to the active trigger circuit and the CC wire. When a second port connects a first port via the cable, if a predefined event happens, the active trigger circuit may trigger the protection circuit to change an electric characteristic of the CC wire, such that the first port may detect a detachment of the second port. In an embodiment, when the active trigger circuit triggers the protection circuit to change the electric characteristic of the CC wire, the active trigger circuit may trigger the protection circuit to raise a voltage of the CC wire to exceed a predefined open-circuit voltage. In an embodiment, the cable may be a USB type-C cable.

In an embodiment, the eMarker may further include a CC communication circuit coupled to the CC wire, for performing BMC (bi-phase mark coded) communication over the CC wire. In an embodiment, the cable may further include a bus power wire, and the active trigger circuit may be further coupled to the bus power wire, so as to determine whether the predefined event happens according to a supply characteristic (e.g., current, voltage and/or temperature) of the bus power wire. In an embodiment, the predefine event may be one of the following: an over-voltage protection event, an over-current protection event, an over-temperature protection event, and an event reflected by impedance sensing.

A cable is provided in an embodiment of the invention; the cable may include a CC wire and an active protection module coupled to the CC wire. When a second port connects a first port via the cable, if a predefined event happens, the active protection module may change an electric characteristic of the CC wire, such that the first port may detect a detachment of the second port. In an embodiment, when the active protection module changes the electric characteristic of the CC wire, the active protection module may raise a voltage of the CC wire to exceed a predefined open-circuit voltage. In an embodiment, the cable may be a USB type-C cable. In an embodiment, the cable may further include a CC communication circuit coupled to the CC wire, for performing BMC communication over the CC wire. In an embodiment, the cable may further include a bus power wire, and the active protection module may be further coupled to the bus power wire, so as to determine whether the predefined event happens according to a supply characteristic of the bus power wire. In an embodiment, the predefined event may be at least one of the following: an over-voltage protection event, an over-current protection event, an over-temperature protection event and an event reflected by impedance sensing.

A method applied to a cable is provided in an embodiment of the invention; the cable may include a CC wire, and the method may include: when a second port connects a first port via the cable, changing an electric characteristic of the CC wire if a predefined event happens, such that the first port may detect a detachment of the second port. In an embodiment, changing the electric characteristic of the CC wire may be raising a voltage of the CC wire to exceed a predefined open-circuit voltage. In an embodiment, the cable may be a USB type-C cable. In an embodiment, the method may further include: performing BMC communication over the CC wire. In an embodiment, the cable may further include a bus power wire, and method may further include: determining whether the predefined event happens according to a supply characteristic of the bus power wire. In an embodiment, the predefined event may be at least one of the following: an over-voltage protection event, an over-current protection event, an over-temperature protection event and an event reflected by impedance sensing.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a cable and an eMarker according to an embodiment of the invention;

FIG. 2 illustrates a flowchart according to an embodiment of the invention;

FIGS. 3a to 3c illustrate operations of ports, cable and eMarker in FIG. 1; and

FIG. 4 illustrates a cable and eMarkers according to an embodiment of the invention.

### DETAILED DESCRIPTION OF PREFERRED EMBODIMENTS

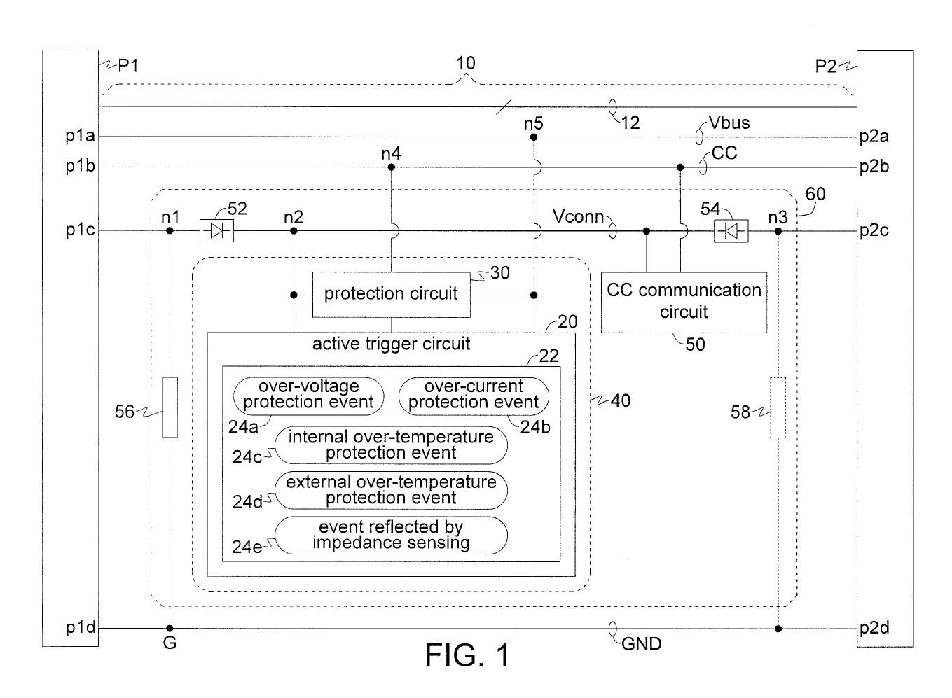

Please refer to FIG. 1 illustrating a cable 10 and an eMarker 60 according to an embodiment of the invention. The cable 10 may be a USB type-C cable, for connecting two ports P1 and P2; the two ports P1 and P2 may respectively belong to two different electronic devices (not shown). The cable 10 may include the eMarker 60, a CC wire, at least a Vbus wire and at least a GND wire; the Vbus wire may be a bus power wire, the CC wire may be a configuration channel wire, and the GND wire may be a ground wire.

The cable 10 may further include a plurality of data wires 12 for supporting USB data interconnect, e.g., a pair of differential signal wires for supporting high-speed interconnect of USB 2.0, several sideband signal wires and/or multiple differential signal wires for supporting SuperSpeed interconnect of USB 3.1.

The port P1 may include pins p1a to p1d; the pin p1a may be a Vbus (bus power) pin defined in USB type-C specification, the pin p1d may be a GND (ground) pin defined in USB type-C specification; the pin p1b may be one of CC1 and CC2 pins defined in USB type-C specification, and the pin p1c may be the other one of the CC1 and CC2 pins. Similarly, the port P2 may include pins p2a to p2d; the pin p2a may be a Vbus pin defined in USB type-C specification, the pin p2d may be a GND pin defined in USB type-C specification; the pin p2b may be one of CC1 and CC2 pins defined in USB type-C specification, and the pin p2c may be the other one of the CC1 and CC2 pins.

When the ports P1 and P2 mutually connect via the cable 10, the pin p1a of the port P1 may be coupled to the pin p2a of the port P2 via the Vbus wire, the pin p1b of the port P1 may be coupled to the pin p2b of the port P2 via the CC wire, and the pin p1d of the port P1 may be coupled to the pin p2d of the port P2 via the GND wire.

In addition, the cable 10 may further include isolation elements 52 and 54 arranged on a Vconn wire, wherein the isolation element 52 may be coupled between nodes n1 and n2, and the isolation element 54 may be coupled between nodes n2 and n3. When the ports P1 and P2 connect via the cable 10, the pin p1c of the port P1 may be coupled to the node n1, the pin p2c of the port P2 may be coupled to the node n3, and the isolation elements 52 and 54 may prevent end-to-end traverse between the pins p1c and p2c along the Vconn wire.

The cable 10 may further include two impedances 56 and 58. The impedance 56 may be coupled between the node n1 and a node G of the GND wire, the impedance 58 may be coupled between the node n3 and the node G. When the cable 10 connects the port P1, the cable 10 may present a terminal resistor, e.g., the resistor Ra defined in USB type-C specification, between the nodes n1 and G by the impedance 56. Similarly, when the cable 10 connects the port P2, the cable 10 may present a terminal resistor, e.g., the resistor Ra defined in USB type-C specification, between the nodes n3 and G by the impedance 58. In an embodiment, the impedances 56 and 58 for presenting the resistor Ra may be implemented by one single impedance; e.g., the impedance 58 may be omitted.

The eMarker 60 of the cable 10 may include a CC communication circuit 50 coupled to the CC wire at a node n4, and further include an active protection module 40 to implement the invention. In an embodiment, the CC communication circuit 50, the active protection module 40, the isolation elements 52 and 54, and the impedances 56 and 58 may be packaged in a same eMarker chip. In another embodiment, the CC communication circuit 50 and the active protection module 40 may be packaged in a same eMarker chip, while the isolation elements 52 and 54 and/or the impedances 56 and 58 may be external elements.

When the ports P1 and P2 connect via the cable 10, if one of the two ports P1 and P2 may operate as a (power) source and the other may operate as a (power) sink, the source port may supply power to the sink port. For convenience of discussion, it is assumed that the port P1 is the source port and the port P2 is the sink port.

As previously explained, the supply safety mechanism of USB PD works only if both the ports P1 and P2 support USB PD; if either one of the two ports does not support USB PD, such supply safety mechanism will not work. In addition, the supply safety mechanism of USB PD fails to consider protecting cable and eMarker. Besides, under USB PD specification, an eMarker is only designed to passively respond messages after receiving request messages from a port, not to actively initiate any supply safety mechanism.

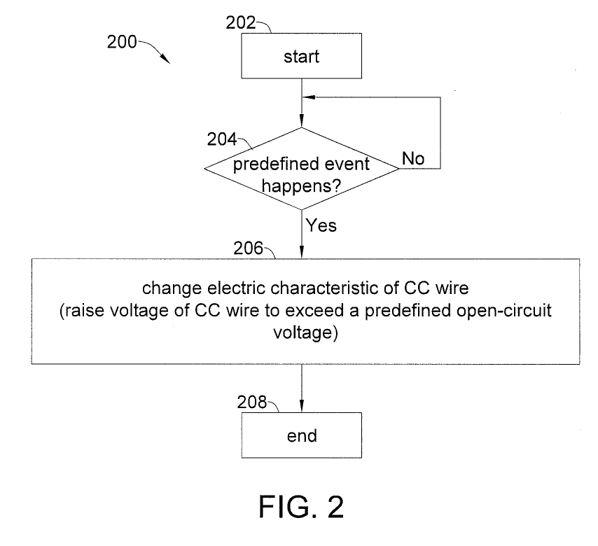

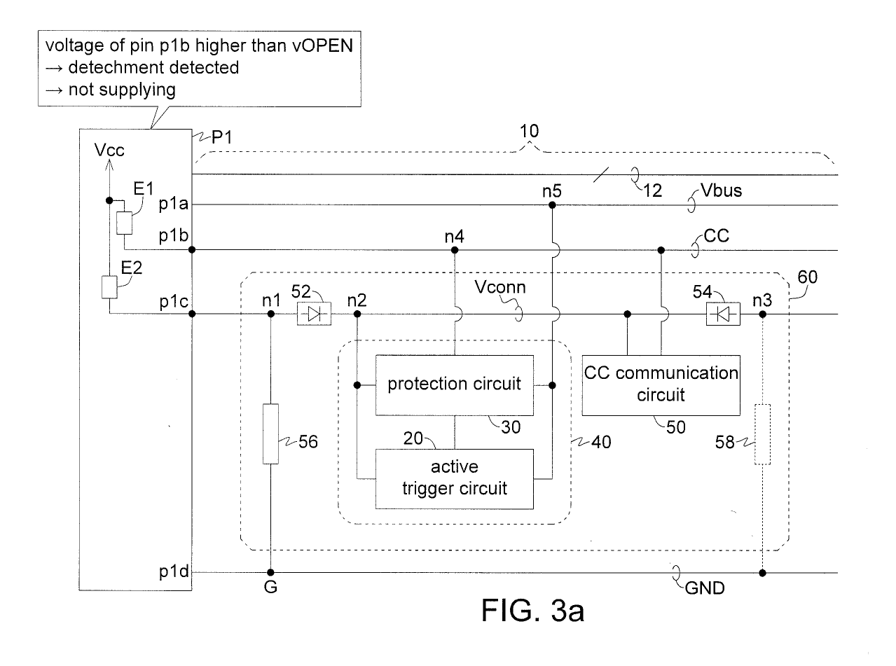

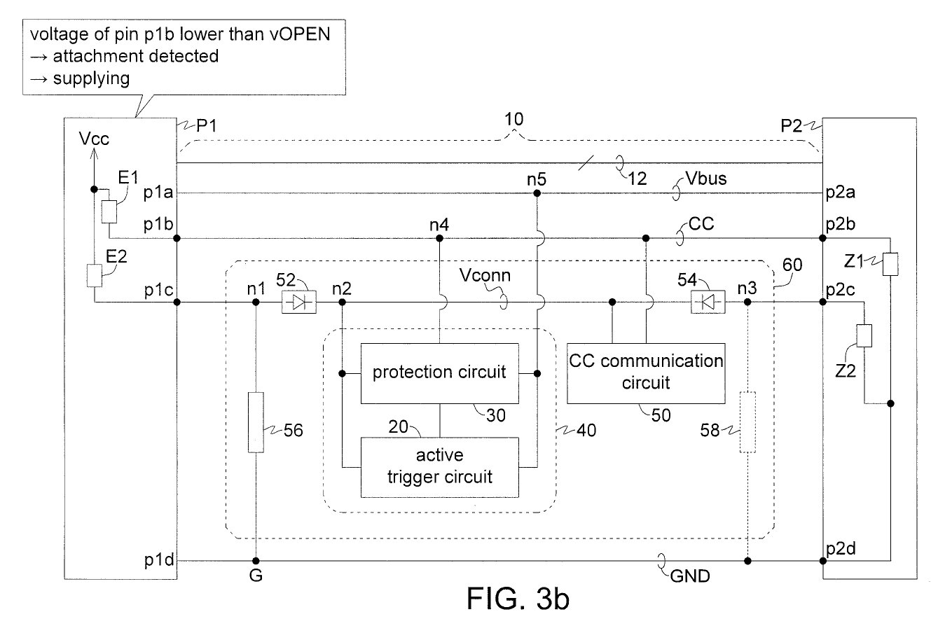

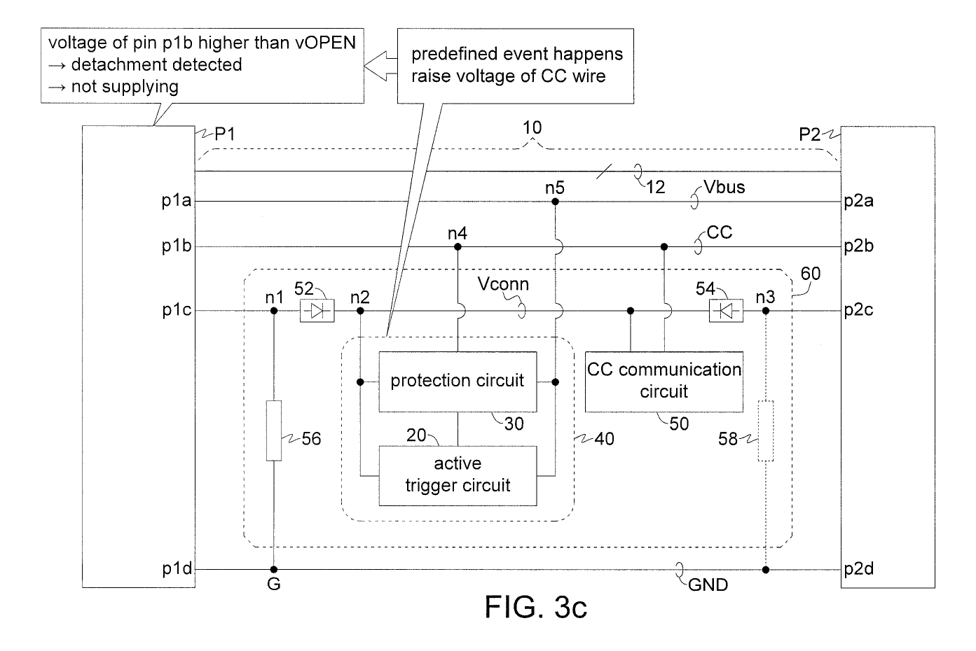

To overcome aforementioned disadvantages of USB PD (and USB type-C) specification, the eMarker 60 of the invention may be equipped with the active protection module 40, which may actively initiate a supply safety mechanism of the invention. The active protection module 40 may include an active trigger circuit 20 and a protection circuit 30. The CC communication circuit 50, the active trigger circuit 20 and the protection circuit 30 may also be coupled to the Vconn and Vbus wires, so as to drain required operation power from the Vconn or Vbus wire. The protection circuit 30 may further be coupled to the active trigger circuit 20, and coupled to the CC wire at the node n4. Along with FIG. 1, please refer to FIG. 2 and FIGS. 3a to 3c. FIG. 2 illustrates a flowchart 200 according to an embodiment of the invention; the eMarker 60 in the cable 10 may execute the flowchart 200 to actively initiate the supply safety mechanism of the invention. FIGS. 3a to 3c illustrate operations of the cable 10 and the ports P1 and P2. It is understood that FIGS. 3a to 3c may only be an example embodiment of the invention; any embodiment allowing the CC communication circuit 50 and the active protection module 40 of the eMarker 60 to drain power and start operating may implement the supply safety mechanism of the invention. In an embodiment, required operation power of the eMarker 60 may be provided via the Vconn wire or the Vbus wire. In another embodiment, operation power of the eMarker 60 may be provided by an external battery or charger (not shown). In the following embodiment, an example with the eMarker 60 powered via the Vconn wire is discussed.

As shown in FIG. 3a, in the port P1 which operates as a source, the pins p1b and p1c may be coupled to a high voltage Vcc (e.g., a 3.3V or 5V dc voltage) respectively via two internal elements E1 and E2; each of the internal elements E1 and E2 may be a resistor (e.g., the resistor Rp defined in USB type-C specification) or a current source (e.g., the current source Ip defined in USB type-C specification). The port P1 may monitor voltages of the pins p1b and p1c to detect if there is another port attached to the port P1. In FIG. 3a, the port P1 already connects the cable 10, but there is no other port connecting the port P1 via the cable 10. Because the node n1 coupled to the pin p1c is also coupled to the GND wire and the ground pin p1d via the impedance 56, the voltage of the pin p1c will be pulled down. However, on the other hand, the CC wire coupled to the pin p1b does not have conductive path to the GND wire, so the voltage of the pin p1b is not pulled down, and will therefore be higher than a predefined open-circuit voltage (e.g., the voltage vOPEN defined in USB type-C specification). Because the voltage of the pin p1b is higher than the predefined open-circuit voltage, the port P1 may determine that there is no other port attached to the port P1; if there is no attachment detected, the port P1 will not supply power (voltage and current) to the Vbus wire.

In FIG. 3b, the sink port P2 connects the port P1 via the cable 10. In the port P2, the pins p2b and p2c may be coupled to the ground pin p2d respectively via two internal impedances Z1 and Z2; wherein each of the internal impedances Z1 and Z2 may be a resistor (e.g., the resistor Rd defined in USB type-C specification). Hence, when the port P2 connects the port P1 via the cable 10, the CC wire, which is coupled to the pin p1b, may be coupled to the grounding GND wire, which is coupled to the pin p2d, via the impedance Z1; voltage of the pin p1b may therefore be pulled down to be lower than the aforementioned predefined open-circuit voltage. When the port P1 detects that the voltage of the pin p1b is lower than the predefined open-circuit voltage, the port P1 may determine that there is another port P2 attached to the port P1. Then, the port P1 may supply power to the port P2 via the Vbus wire in the cable 10; and, the port P1 or P2 may supply power to the Vconn wire via the node n1 or n3, such that the CC communication circuit 50 and the active protection module 40 in the eMarker 60 may drain power from the Vconn wire to start operating, and the active protection module 40 may execute the flowchart 200 shown in FIG. 2. Main steps of the flowchart 200 may be described as follows.

Step 202: as shown in FIG. 3b, when the port P1 supplies power to the port P2 via the cable 10, the eMarker 60 may start the flowchart 200, and the active protection module 40 may proceed to step 204 to implement the supply safety mechanism of the invention. In addition, the CC communication circuit 50 may perform bi-phase mark coded communication defined in USB PD over the CC wire, including: receiving SOP′ (with SOP denoting start of packet) packets sent by the port P1 or P2, and sending SOP′ packets in return. However, it is emphasized that the packets transmissions between the ports P1 and P2 are not mandatory nor necessary for the supply safety mechanism of the invention to start and proceed; whether the packets transmissions between the ports P1 and P2 occur or not, the eMarker 60 may independently implement the supply safety mechanism of the invention, as long as the eMarker 60 is supplied with power.

Step 204: if a predefined event 22 (FIG. 1) happens, then the active trigger circuit 20 in the active protection module 40 may trigger the protection circuit 30 to proceed to step 206, otherwise iterate to step 204. In an embodiment, the predefined event 22 may reflect supply abnormal events of the Vbus wire. For example, as shown in FIG. 1, the predefined event 22 may include an over-voltage protection event 24a, an over-current protection event 24b, an internal over-temperature protection event 24c, an external over-temperature protection event 24d, and an event 24e reflected by impedance sensing, etc. If any of the events occurs, the active protection module 40 may proceed to step 206.

To detect abnormal events, the active trigger circuit 20 may be coupled to the Vbus wire at the node n5, so as to determine whether the predefined event 22 happens according to one or more supply characteristics (e.g., current, voltage and/or temperature) of the Vbus wire. For example, if voltage of the Vbus wire is too high (higher than a safety voltage value), the active trigger circuit 20 may determine that the over-voltage protection event 24a has happened. If current of the Vbus wire is too large (larger than a safety current value), the active trigger circuit 20 may determine that the over-current protection event 24b has happened. In addition, the eMarker 60 may sense temperature according to changes of its semiconductor characteristics; for example, the eMarker 60 may have an internal temperature sensor to sense chip internal temperature. If the temperature is too high (higher than an internal safety temperature), the active trigger circuit 20 may determine that the internal over-temperature event 24c has happened. In an embodiment, the eMarker 60 may connect an external temperature sensor (e.g., a thermistor, not shown) to sense temperature; if the temperature is too high (higher than a safety temperature), the active trigger circuit 20 may determine that the external over-temperature event 24d has happened. In an embodiment, the eMarker 60 may sense supply characteristic of the Vbus wire by an impedance (not shown) coupled to the Vbus wire; for example, if cross voltage of the impedance is too high, it may reflect that current of the Vbus wire is too large, and the active trigger circuit 20 may determine that the event 24e reflected by impedance sensing has occurred.

Step 206 (FIG. 2): as shown in FIG. 3c, the active trigger circuit 20 may trigger the protection circuit 30 when the predefined event 22 happens, and the protection circuit 30 may change electric characteristic of the CC wire when triggered, such that the source port P1 may detect that the sink port P2 has detached, even though the ports P1 and P2 may actually still remain connected via the cable 10. In an embodiment, the protection circuit 30 may raise the voltage of the CC wire to exceed the predefined open-circuit voltage mentioned in FIGS. 3a and 3b (e.g., the voltage vOPEN defined in USB type-C specification). Because the voltage vOPEN defined in USB type-C specification may be 1.65V or 2.75V, in an embodiment of step 206, when the predefined event 22 happens, the protection circuit 30 may cause the voltage of the CC wire to be higher than the maximum one of multiple predefined open-circuit voltages, e.g., higher than 2.75V. In an embodiment, the protection circuit 30 may couple the CC wire to the Vconn wire or the Vbus wire when the active trigger circuit 20 triggers, and utilize the voltage of the Vconn wire or the Vbus wire to cause the voltage of the CC wire to be higher than the predefined open-circuit voltage, because the voltage supplied to the Vconn wire or the Vbus wire will be higher than the predefined open-circuit voltage.

As explained by FIG. 3a, when the port P1 detects that the voltage of the pin p1b is higher than the predefined open-circuit voltage, the port P1 will determine that there is no other port attached to the port P1, and the port P1 will not supply power to the Vbus wire due to absence of attachment. Therefore, in FIG. 3c, when the predefined event happens and the protection circuit 30 raises the voltage of the CC wire to exceed the predefined open-circuit voltage, the port P1 will also detect that the voltage of the pin p1b is higher than the predefined open-circuit voltage, and determine that the port P2 has been detached, even though the port P2 may remain connected to the port P1 via the cable 10.

Step 208: when the source port P1 detects that the sink port P2 has been detached, the port P1 will stop supplying power to the Vbus wire, so the supply abnormal event may stop, the supply safety mechanism of the invention may be achieved, and the flowchart 200 may end. When the port P1 stops supplying power to the Vbus wire, power supplied to the Vconn wire also stops, and the eMarker 60 may stop operating. Afterwards, since the port P2 remains connected to the port P1 via the cable 10, the port P1 may redetect that the port P2 is attached, and restart supplying power to the Vbus wire; the flowchart 200 may also start again. In an embodiment, the cable 10 may be unplugged and plugged again between the ports P1 and P2, so the flowchart 200 may be executed again.

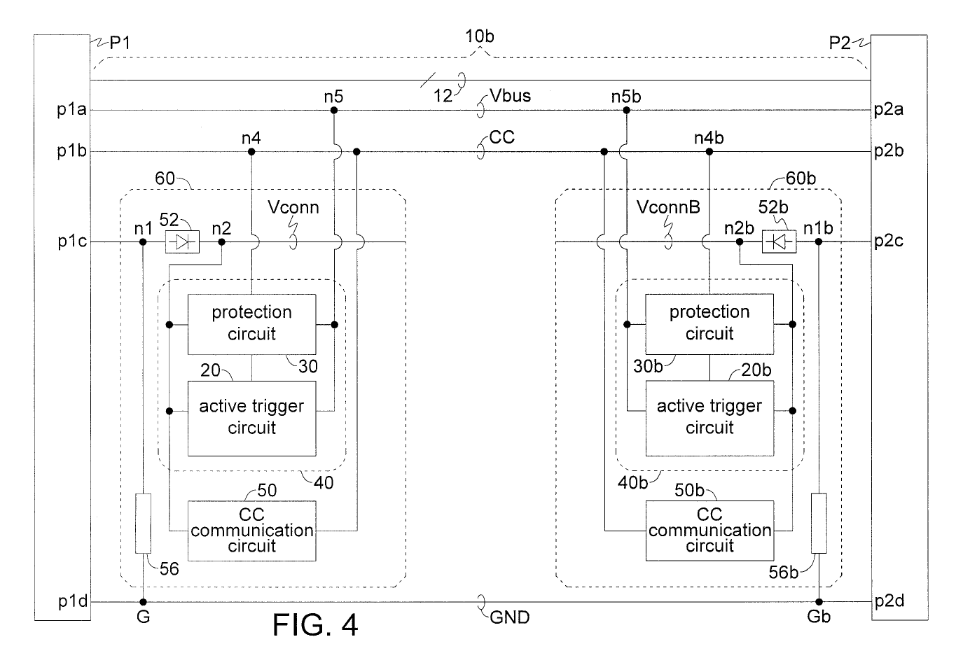

Please refer to FIG. 4 illustrating a cable 10b and eMarkers 60 and 60b according to an embodiment of the invention. The cable 10b may be a USB type-C cable, for connecting two ports P1 and P2; the ports P1 and P2 may respectively belong to different electronic devices (not shown). The cable 10b may include the eMarkers 60 and 60b, a CC wire, at least a Vbus wire and at least a GND wire; the Vbus wire may be a bus power wire, the CC wire may be a configuration channel wire, and the GND wire may be a ground wire. The cable 10b may also include multiple data wires 12 for supporting USB data interconnect, e.g., a pair of differential signal wires for supporting high-speed interconnect of USB 2.0, several sideband signal wires and/or multiple differential signal wires for supporting SuperSpeed interconnect of USB 3.1.

The port P1 may include pins p1a to p1d; the pin p1a may be a Vbus pin defined in USB type-C specification, the pin p1d may be a GND pin defined in USB type-C specification; the pin p1b may be one of CC1 and CC2 pins defined in USB-type-C specification, and the pin p1c may be the other one of the CC1 and CC2 pins. Similarly, the port P2 may include pins p2a to p2d; the pin p2a may be a Vbus pin defined in USB type-C specification, the pin p2d may be a GND pin defined in USB type-C specification; the pin p2b may be one of CC1 and CC2 pins defined in USB-type-C specification, and the pin p2c may be the other one of the CC1 and CC2 pins.

When the ports P1 and P2 connect via the cable 10b, the pin p1a of the port P1 may be coupled to the pin p2a of the port P2 via the Vbus wire, the pin p1b of the port P1 may be coupled to the pin p2b of the port P2 via the CC wire, and the pin p1d of the port P1 may be coupled to the pin p2d of the port P2 via the GND wire.

In addition, the cable 10b may further include isolation elements 52 and 52b. The isolation element 52 may be arranged on a Vconn wire, coupled between nodes n1 and n2. The isolation element 52b may be arranged on a VconnB wire, coupled between nodes n1b and n2b. When the ports P1 and P2 connect via the cable 10b, the pin p1c of the port P1 may be coupled to the node n1, the pin p2c of the port P2 may be coupled to the node n1b.

The cable 10b may further include two impedances 56 and 56b. The impedance 56 may be coupled between the node n1 and a node G of the GND wire, the impedance 56b may be coupled between the node n1b and a node Gb of the GND wire. When the cable 10 connects the port P1, the cable 10b may present a terminal resistor, e.g., the resistor Ra defined in USB type-C specification, between the nodes n1 and G by the impedance 56. Similarly, when the cable 10b connects the port P2, the cable 10b may present a terminal resistor, e.g., the resistor Ra defined in USB type-C specification, between the nodes nib and G by the impedance 56b.

The eMarker 60 of the cable 10b may include a CC communication circuit 50 coupled to the CC wire at a node n4, and further include an active protection module 40 to implement the invention. Similarly, the eMarker 60b may include a CC communication circuit 50b coupled to the CC wire at a node n4b, and further include an active protection module 40b to implement the invention. The active protection module 40 may include an active trigger circuit 20 and a protection circuit 30, while the active protection module 40b may include an active trigger circuit 20b and a protection circuit 30b. The CC communication circuit 50, the active trigger circuit 20 and the protection circuit 30 may be coupled to the Vconn and Vbus wires, so as to drain required operation power from the Vconn or Vbus wire. The protection circuit 30 may also be coupled to the active trigger circuit 20, and coupled to the CC wire at the node n4. The protection circuit 30b may also be coupled to the active trigger circuit 20b, and coupled to the CC wire at the node n4b. The CC communication circuit 50b, the active trigger circuit 20b and the protection circuit 30b may be coupled to the VconnB and Vbus wires, so as to drain required operation power from the VconnB or Vbus wire. FIG. 4 merely illustrates an embodiment of the invention, while any arrangement which allows the CC communication circuits 50 and 50b and the active protection modules 40 and 40b to drain power and start operation may be utilized to implement the supply safety mechanism of the invention. In an embodiment, required operation power of the eMarkers 60 and 60b may be provided via the Vconn wire or the Vbus wire. In another embodiment, operation power of the eMarkers 60 and 60b may be provided by an external battery or charger (not shown). In the following embodiment, an example with the eMarkers 60 and 60b powered respectively via the Vconn wire and the VconnB wire is discussed.

In an embodiment implemented according to FIG. 4-38 and associated description of USB type-C specification release 1.2, at least one of the active protection modules 40 and 40b may execute steps 204 and 206 shown in FIG. 2. When the ports P1 and P2 mutually connect via the cable 10b, one of the ports P1 and P2 may supply power to the other via the Vbus wire of the cable 10b, and only one of the eMarkers 60 and 60b may drain power, such that the corresponding one of the active protection modules 40 and 40b may execute steps 204 and 206 shown in FIG. 2. The active trigger circuit 20 (or 20b) may be coupled to the Vbus wire at a node n5 (or n5b) to determine whether a supply abnormal event happens according to supply characteristic (e.g., current, voltage, temperature, etc.) of the Vbus wire, and may trigger the protection circuit 30 (or 30b) when the abnormal event happens (step 204), such that the protection circuit 30 (or 30b) may raise voltage of the CC wire to exceed the predefined open-circuit voltage (step 206), and cause the source port to detect a detachment when the two ports still remain physically connected, and therefore stop supplying power to the Vbus wire; as a result, the abnormal event will be stopped. The supply safety mechanism of the invention may be effectively implemented even if there is only one of the active protection modules 40 and 40b to raise the voltage of the CC wire to exceed the predefined open-circuit voltage when the abnormal events occur.

In another embodiment (not illustrated) implemented according to FIG. 5-7 and associated description of USB type-C specification release 1.2, both the active protection modules 40 and 40b may execute steps 204 and 206 shown in FIG. 2.

To sum up, the invention may equip eMarker and cable with active (self-initiated) supply safety mechanism, which may actively trigger protection in response to supply abnormal events, so the abnormal events may be stopped and suppressed. Accordingly, the eMarker and cable of the invention will not be limited to passive functionality defined in USB PD specification, and not be limited to passively responding messages when receiving request messages from the ports. Comparing to existed supply safety mechanism of USB PD which requires both ports P1 and P2 to support USB PD, the eMarker and cable of the invention may actively maintain supply safety even if both ports P1 and P2 do not support USB PD. Furthermore, the invention may not only protect the two ports connected via the cable, but also protect the eMarker and the cable itself.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An eMarker for a cable; the cable comprising a CC (configuration channel) wire, and the eMarker comprising:
an active trigger circuit; and
a protection circuit coupled to the active trigger circuit and the CC wire;
wherein when a second port connects a first port via the cable, if a predefined event happens, the active trigger circuit triggers the protection circuit to change an electric characteristic of the CC wire, such that the first port detects a detachment of the second port.

2. The eMarker of claim 1, wherein when the active trigger circuit triggers the protection circuit to change the electric characteristic of the CC wire, the active trigger circuit triggers the protection circuit to raise a voltage of the CC wire to exceed a predefined open-circuit voltage.

3. The eMarker of claim 1, wherein the cable is a USB type-C cable.

4. The eMarker of claim 1 further comprising:
a CC communication circuit coupled to the CC wire, for performing BMC (bi-phase mark coded) communication over the CC wire.

5. The eMarker of claim 1, wherein the cable further comprises a bus power wire, and the active trigger circuit is further coupled to the bus power wire, so as to determine whether the predefined event happens according to a supply characteristic of the bus power wire.

6. The eMarker of claim 1, wherein the predefined event is an over-voltage protection event.

7. The eMarker of claim 1, wherein the predefined event is an over-current protection event.

8. The eMarker of claim 1, wherein the predefined event is an over-temperature protection event.

9. The eMarker of claim 1, wherein the predefined event is an event reflected by impedance sensing.

10. A cable, comprising:
a CC wire; and
an active protection module, coupled to the CC wire;
wherein when a second port connects a first port via the cable, if a predefined event happens, the active protection module changes an electric characteristic of the CC wire, such that the first port detects a detachment of the second port.

11. The cable of claim 10, wherein when the active protection module changes the electric characteristic of the CC wire, the active protection module raises a voltage of the CC wire to exceed a predefined open-circuit voltage.

12. The cable of claim 10 being a USB type-C cable.

13. The cable of claim 10 further comprising:
a CC communication circuit coupled to the CC wire, for performing BMC communication over the CC wire.

14. The cable of claim 10 further comprising a bus power wire, wherein the active protection module is further coupled to the bus power wire, so as to determine whether the predefined event happens according to a supply characteristic of the bus power wire.

15. The cable of claim 10, wherein the predefined event is at least one of the following: an over-voltage protection event, an over-current protection event, an over-temperature protection event and an event reflected by impedance sensing.

16. A method applied to a cable, the cable comprising a CC wire, and the method comprising:
when a second port connects a first port via the cable, changing an electric characteristic of the CC wire if a predefined event happens, such that the first port detects a detachment of the second port.

17. The method of claim 16, wherein changing the electric characteristic of the CC wire is raising a voltage of the CC wire to exceed a predefined open-circuit voltage.

18. The method of claim 16, wherein the cable is a USB type-C cable.

19. The method of claim 16 further comprising:
performing BMC communication over the CC wire.

20. The method of claim 16, wherein the cable further comprises a bus power wire, and method further comprises: determining whether the predefined event happens according to a supply characteristic of the bus power wire.

21. The method of claim 16, wherein the predefined event is at least one of the following: an over-voltage protection event, an over-current protection event, an over-temperature protection event and an event reflected by impedance sensing.
